(19) United States
(12) Patent Application Publication
(10) Pub. No.: US 2005/0206790 A1
(43) Pub. Date: Sep. 22, 2005

(54) METHOD AND APPARATUS FOR PROCESSING VIDEO SIGNALS

(76) Inventor: Po-Wei Chao, Taipei Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/907,122

(22) Filed: Mar. 21, 2005

(30) Foreign Application Priority Data
Mar. 22, 2004 (TW) 093107641

(51) Int. Cl. H04N 5/14

(52) U.S. Cl. 348/700

(57) ABSTRACT

A method for processing video signals including three fields which are sequentially related involves: determining whether field motion exists between the first field and the second field and generating a first detection signal corresponding to the second field; and determining whether the first field is capable of being combined with the second field according to the first detection signal.

### BACKGROUND OF INVENTION

1. Field of the Invention

The invention relates to an apparatus for processing video signals, and more particularly, to an apparatus for determining a film mode of the video signals.

2. Description of the Prior Art

In interlaced scanning, odd scan lines and even scan lines of a frame are scanned in sequence. Thus, each frame is actually composed of two fields: an odd field and an even field. Progressive scanning, which is also referred to as non-interlaced scanning, combines the odd and the even field into one frame and then sequentially scans the frame in double horizontal frequency so that the quality of the display image is improved.

Since field motion may exist between two fields, combining two fields having field motion into a frame may result in a sawtooth phenomenon within the frame and thereby deteriorate image quality. Therefore, before determining a merge direction of each field of a video data, the film mode, e.g., 2:2 pull-down or 3:2 pull-down, of the video data should be determined first.

The conventional method needs to determine a specific number of fields to identify the film mode of the video data. However, the film mode of the video data may not be consistent from the beginning to the end, and furthermore, switching the film mode may have no regulation. As a result, it may be impossible to identify the film mode of the video data of the prior art and thereby impossible to determine the merge direction of each field within the video data. In this situation, the image quality of the video data is decreased.

### SUMMARY OF INVENTION

It is therefore an objective of the claimed invention to provide a method and apparatus for determining the merge direction of a field according to the detection results of field motion.

According to the claimed invention, a method for processing video signals is disclosed. The method includes: determining whether field motion exists between the first field and the second field and thereupon generating a first detection signal corresponding to the second field; and determining whether the first field is capable of being combined with the second field according to the first detection signal.

A device for determining video signals is disclosed in the invention. The device includes: a first motion detector for determining whether field motion exists between the first field and the second field and for thereupon generating a first detection signal; and a decision unit coupled to the first motion detector for determining whether the first field is capable of being combined with the second field according to the first detection signal.

### BRIEF DESCRIPTION OF DRAWINGS

FIG. 1 is a block diagram of a video detector according to the invention.

FIG. 2 is a diagram of a video sequence according to the film mode of 2:2 pull-down.

FIG. 3 is a diagram of a video sequence according to the film mode of 3:2 pull-down.

FIG. 4 is a diagram of a video sequence having different film modes.

FIG. 5 is a flowchart of a method for determining video signals according to the invention.

FIG. 6 is another diagram of a video sequence having different film modes.

### DETAILED DESCRIPTION

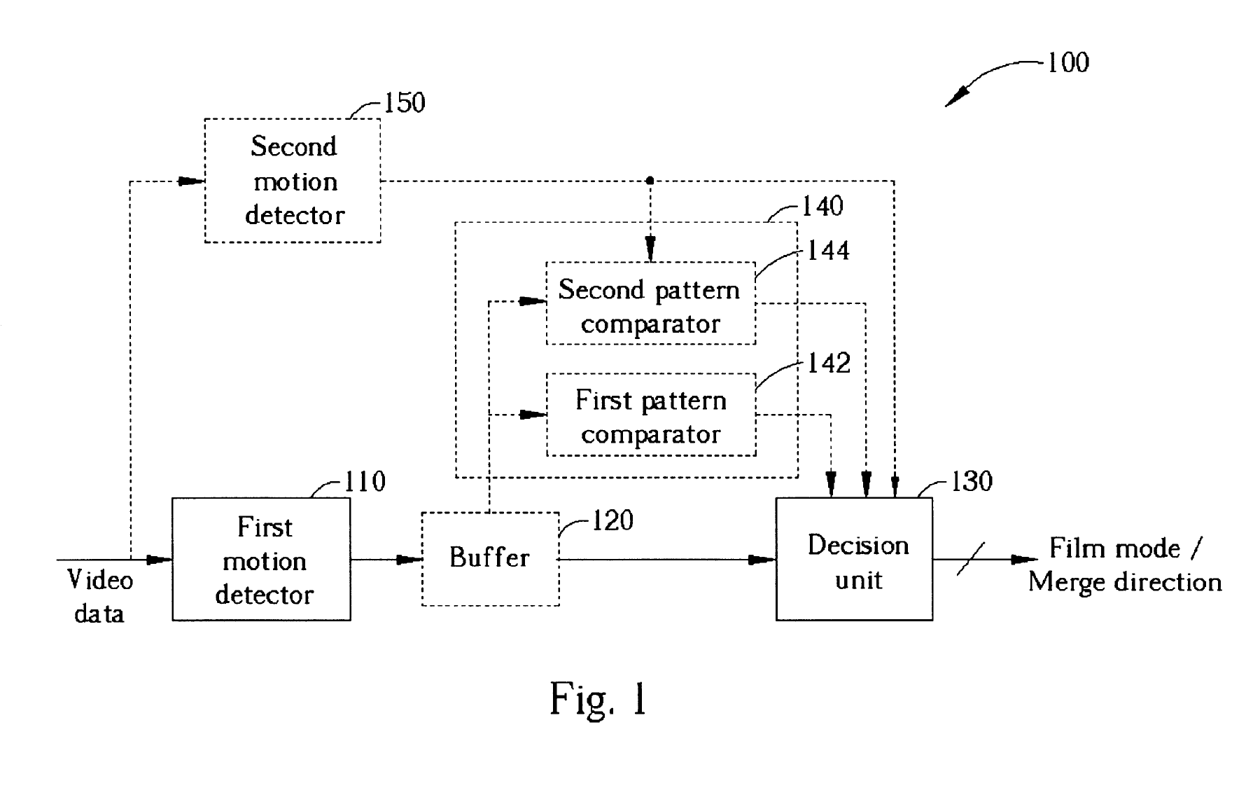

Please refer to FIG. 1, which depicts a block diagram of a video detector 100 according to the invention. The video detector 100 comprises a first motion detector 110 for determining whether field motion exists between a first field and a second field, and for thereupon generating a first detection signal corresponding to the second field, wherein the first and the second fields are adjacent fields. A buffer 120 is for temporally storing the data outputted from the first motion detector 110. A decision unit 130 is for determining the merge direction of the second field according to the first detection signal. A pattern detector 140 is for determining the pattern of a plurality of detection signals to assist the decision unit 130 to decide the merge direction of the second field. Additionally, a second motion detector 150 is for determining frame motion to generate a frame motion signal. The frame motion signal is regarded as a reference by the decision unit 130 to improve the detection correctness of the video detector 100 of the invention.

In an embodiment, the first motion detector 110 is used as a field motion detector, and the second motion detector 150 is used as a frame motion detector. As the architecture of the first motion detector 110 and the second motion detector 150 are well known in the art, further details are omitted here.

In one embodiment, the pattern detector 140 comprises a first pattern comparator 142 for determining whether a plurality of detection signals matches a first pattern; and a second pattern comparator 144 for determining whether a plurality of detection signals matches a second pattern. In an embodiment, the first pattern corresponds to the film mode of 2:2 pull-down, and the second pattern corresponds to the film mode of 3:2 pull-down. In addition, the second pattern comparator 144 can verify the determined film mode according to the frame motion signals outputted from the second motion detector 150.

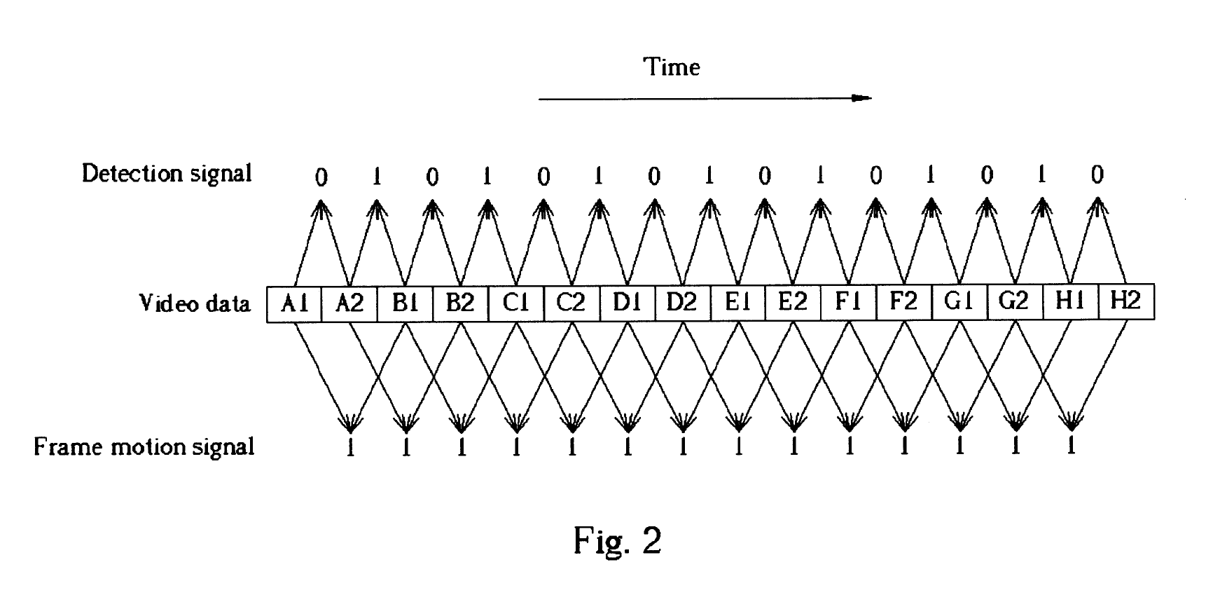

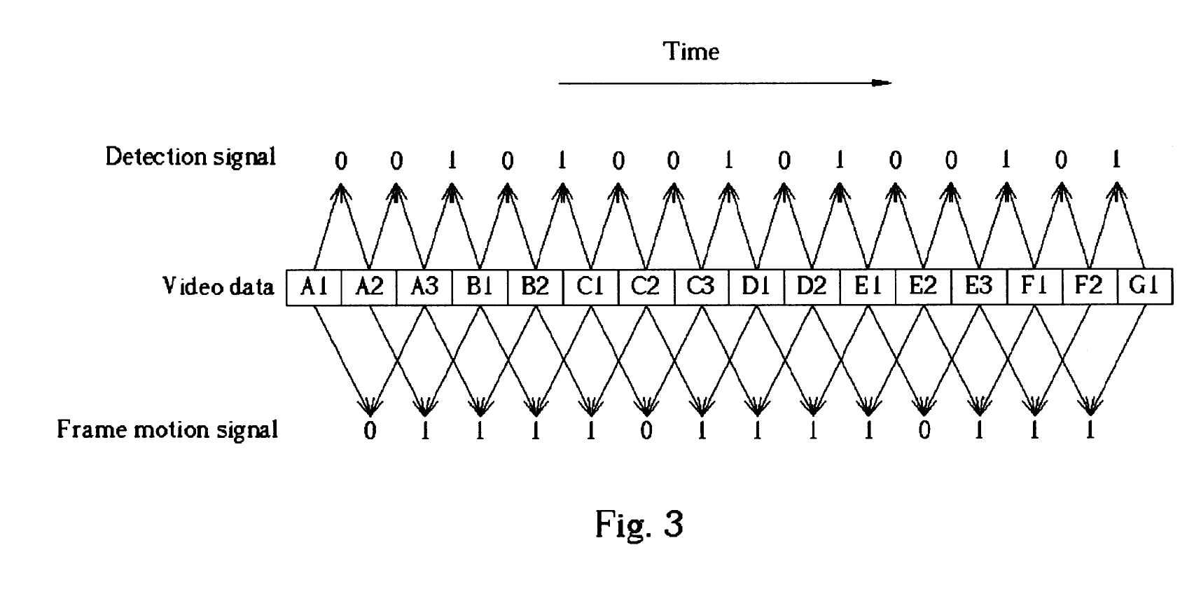

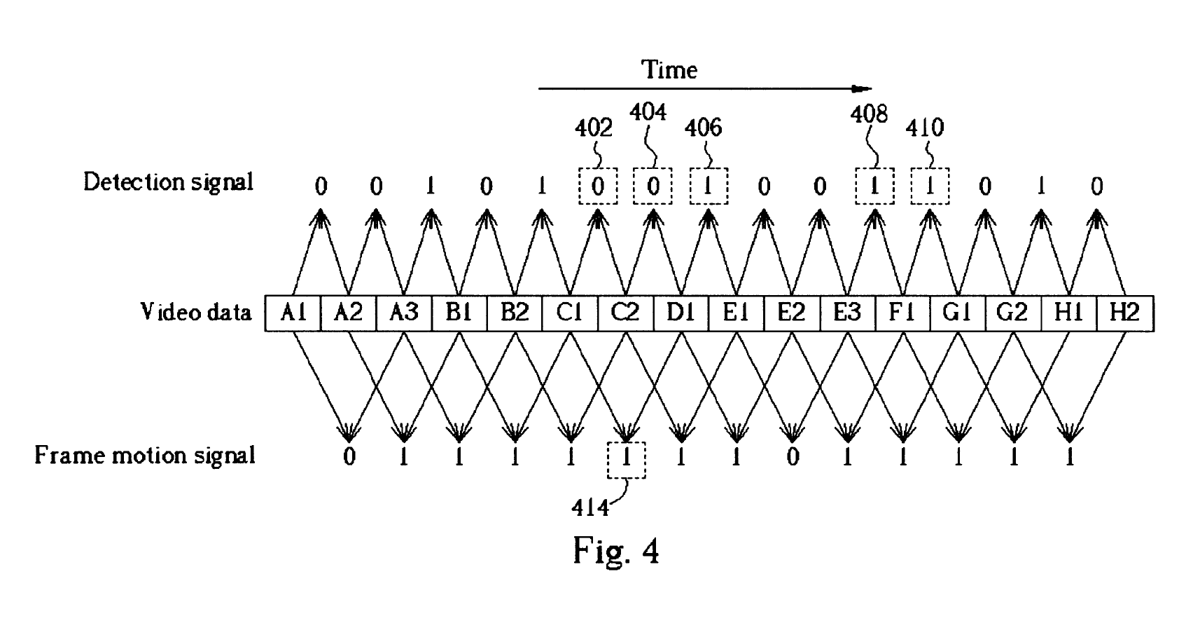

FIG. 2, FIG. 3, and FIG. 4 are diagrams of video sequences. Each field is labeled with a letter plus a number. Fields having the same letter are generated from the same film frame and each of the fields is assigned with a corresponding number. If one detection signal corresponds to a first value (such as logic 0), it means no field motion exists between the two fields corresponding to the detection signal, e.g. the fields A1 and A2 in FIG. 2. If one detection signal corresponds to a second value (such as logic 1), it means field motion exists between the two fields corresponding to the detection signal, e.g. the fields B2 and C1 in FIG. 2. In addition, if one frame motion signal corresponds to the second value (logic 1), it means frame motion exists between the two fields corresponding to the frame motion signal, e.g. the fields A1 and B1 in FIG. 2. Similarly, if one frame motion signal corresponds to the first value (logic 0), it means no frame motion exists between the two fields corresponding to the frame motion signal, e.g. the fields C1 and C3 shown in FIG. 3.

When the film mode of the video sequence is 2:2 pull-down, as shown in FIG. 2, a pattern of “01” repeatedly appears in the sequence of the detection signal and all frame motion signals are logic 1.

When the film mode of the video sequence is 3:2 pull-down, as shown in FIG. 3, a pattern of “00101” repeatedly appears in the sequence of the detection signal and a pattern of “01111” is repeatedly presented in the sequence of the frame motion signal.

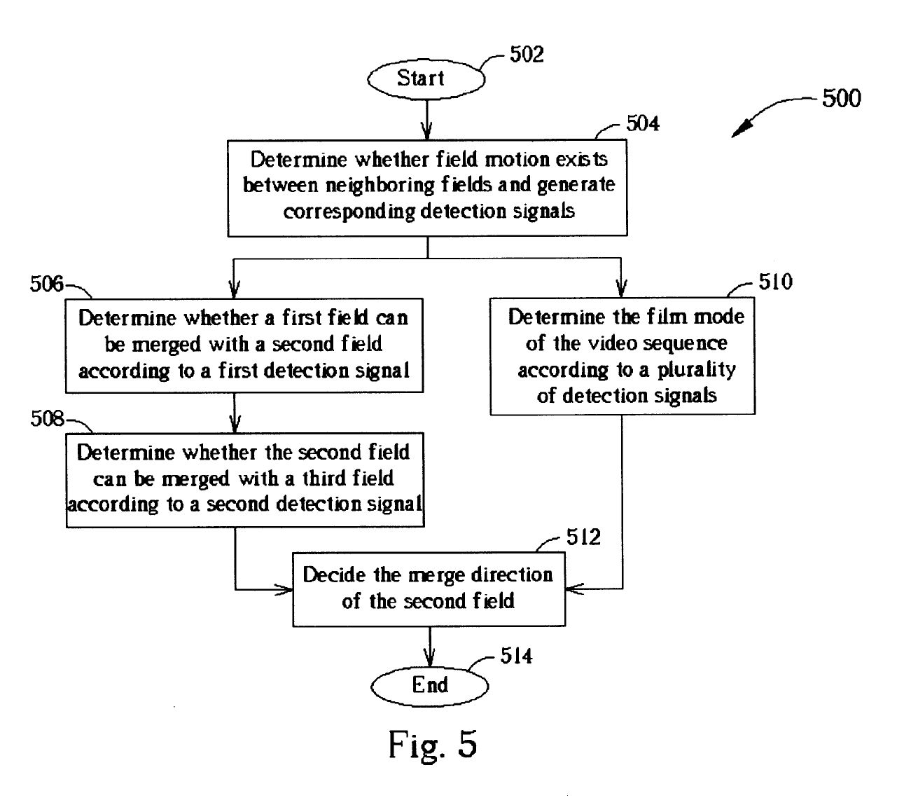

FIG. 4 depicts a diagram of a video sequence with a portion of 2:2 pull-down and a portion of 3:2 pull-down. Please refer to FIG. 5, which depicts a flowchart of a method for determining video signals according to the invention. The steps of the flowchart 500 are described as follows:

In step 504, the first motion detector 110 determines field motion and generates a detection signal. For example, receiving a field E1, the first motion detector 110 generates a detection signal 406 corresponding to the field E1 according to the field E1 and the neighboring field D1.

In step 506, receiving the detection signal 404, the decision unit 130 decides a possible merge direction for the field D1 based on the detection signal 404. For example, the detection signal 404 is logic 0. Thus, the decision unit 130 maybe concludes that the field D1 can be merged with the preceding field C2, accordingly.

In step 508, the decision unit 130 further determines the possible merge direction for the field D1 according to the detection signal 406. As shown in FIG. 4, the detection signal 406 is logic 1, which represents that field motion exists between the fields E1 and D1. Thus, to avoid sawtooth images, the decision unit 130 decides that the field D1 cannot merge the succeeding field E1.

In this embodiment, the decision unit 130 decides the merge direction of the field D1 based on one or both of the results obtained in steps 506 and 508, and thereupon outputs a first indication signal in step 512. The first indication signal represents the merge direction of the field by different values and characters. For example, the first indication signal represents that the field can only be merged with the preceding field by value “0”; represents that the field can only be merged with the succeeding field by value “1”; represents that the field can only be merged with the preceding field or the succeeding field by value “2”; and represents that field cannot be merged with other fields by value “3”. In this embodiment, the decision unit 130 can output a value “0” as the first indication signal to represent that the field D1 can be merged with the preceding field C2.

If two improper fields are merged into one frame, it easily results in sawtooth phenomenon within the frame. Avoiding an incorrect decision, the method of the invention can further utilize the second motion detector 150 to verify the determining result of the first motion detector 110.

In a second embodiment of the invention, the second motion detector 150 of the video detector 100 determines whether frame motion exists between two fields. The determining result of the second motion detector 150 can be employed to verify the correctness of the detection signal generated by the first motion detector 110. In a preferred embodiment, a threshold value used by the second motion detector 150 while detecting frame motion is smaller than a threshold value used by the first motion detector 110 while detecting field motion. In other words, the determination of the second motion detector 150 is stricter than the first motion detector 110.

The threshold value of the first motion detector 110 needs to be set properly. For example, the fields D1 and C2 of FIG. 4 are assumed from different film frames and therefore field motion exists between the two fields, so the detection signal 404 should be logic 1. If the threshold value used by the first motion detector 110 is too large and the pixel difference between the fields D1 and C2 is smaller than the threshold value (i.e. the fields D1 and C2 are similar), the first motion detector 110 mistakenly concludes that there is no field motion between the fields D1 and C2 and outputs an incorrect detection signal 404 (at logic 0 state) as shown in FIG. 4. The incorrect detection signal 404 leads the decision unit 130 to make an inaccurate decision. In FIG. 4, for example, both the detection signals 402 and 404 are logic 0, which represents that no field motion exists between the fields C2 and C1, and that no field motion exists between fields D1 and C2. Accordingly, the decision unit 130 concludes that the fields D1 and C1 are generated from the same film frame. However, a frame motion signal 414 corresponding to the field D1 is logic 1 as shown in FIG. 4, which represents there is frame motion between fields D1 and C1. Accordingly, it can be determined that the fields D1 and C1 do not come from the same film frame. As a result, in the second embodiment of the invention, the decision unit 130 overthrows the correctness of the detection signal 404 according to the frame motion signal 414 in step 506 or 512 and determines that the field D1 cannot be merged with the field C2. In addition, according to the determining result in step 508 as mentioned above, the field D1 cannot be merged with the field E1. The decision unit 130 outputs a value “3” as the indication signal corresponding to the field D1 accordingly. In other words, the field D1 should be de-interlaced by using intra-field interpolation.

In general, a steady video sequence has specific film mode, such as 3:2 pull-down, 2:2 pull-down, or another pull-down ratio. In a preferred embodiment, the video detector 100 can use the film mode information of the video sequence to assist in determining the merge direction of the field. Before the film mode of the video sequence is determined, the video detector 100 can use detection signals or both the detection signals and the frame motion signals to determine the merge direction of fields. As in the above illustration, the method and architecture of the invention can be applied in regular, part regular, and irregular video sequences to avoid merging incorrect fields.

In a third embodiment of the invention, the video detector 100 first utilizes the pattern detector 140 to detect whether the detection signals match a predetermined film mode in step 510. In a preferred embodiment, the pattern detector 140 simultaneously uses the first pattern comparator 142 and the second pattern comparator 144 to perform a pattern comparison in order to determine whether the video sequence matches the first pattern, the second pattern or without regulation. In practice, the number of the detection signals compared by the first pattern comparator 142 and the second pattern comparator 144 are not necessarily the same.

For example, receiving the detection signal 404 of the field D1, the first pattern comparator 142 detects if the last two detection signals including the detection signal 404 match “0X” or “X0” pattern to determine whether the current video sequence matches the film mode of 2:2 pull-down. In this example, “X” means the detection signal can be logic 0 or logic 1. As shown in FIG. 4, the detection signal 404 and a previous detection signal 402 are both logic 0 and that matches the “0X” or “X0” pattern. Accordingly, the first pattern comparator 142 concludes that the current video sequence may be 2:2 pull-down. Concurrently, the second pattern comparator 144 detects if the last five detection signals including the detection signal 404 match “00X0X,” “0X0X0,” “X0X00,” “0X00X,” or “X00X0” pattern to determine whether the current video sequence matches the film mode of 3:2 pull-down. As shown in FIG. 4, the field D1 and preceding four fields (i.e. fields B1, B2, C1 and C2) correspond to detections “10100”, which matches the “X0X00” pattern. Thus, the second pattern comparator 144 concludes that the current video sequence may be 3:2 pull-down.

In step 510, if any of the comparisons of the first and second pattern comparators 142 and 144 is positive, this means that the current video sequence is steady. As a result, the decision unit 130 can apply the above methods to determine the merge direction of the field D1 in step 512. In practice, the video detector 100 can use only one pattern comparator to determine whether the received video sequence is steady.

In a fourth embodiment of the invention, the pattern detector 140, in step 510, further uses the detection result of the second motion detector 150 to verify the correctness of pattern detection. For example, as shown in FIG. 4, the frame motion signals correspond to the five fields prior to the field D1, i.e. fields A3, B1, B2, C1, and C2, are “01111” and that matches the sequence pattern of 3:2 pull-down in FIG. 3. Therefore, if the frame motion signal 414 corresponding to the following field D1 is logic 0, the pattern of 3:2 pull-down is confirmed. However, if the frame motion signal is logic 1, not logic 0, this means the film mode determined by the second pattern comparator 144, 3:2 pull-down, may be incorrect. As a result, the second pattern comparator 144, in step 510, changes its determination to indicate that the film mode of the current video sequence is not 3:2 pull-down according to the detection result of the second motion detector 150.

In step 512, the decision unit 130 outputs a value “0” as the first indication signal to represent that the field D1 can only be merged with the preceding field C2 based on the result of the above steps.

Regarding another field F1 in FIG. 4, a detection signal 408 corresponding to the field F1 is logic 1, and this means there is field motion between the field F1 and a preceding field E3. Accordingly, the decision unit 130 concludes that the field F1 cannot be merged with the preceding field E3 in step 506. A detection signal 410 corresponding to a field G1 posterior to the field F1 is also logic 1, and this means there is also field motion between the field F1 and the succeeding field G1. Therefore, the decision unit 130 concludes that the field F1 cannot be merged with the succeeding field G1, either. As a result, the decision unit 130, in step 512, outputs a value “3” as the first indication signal to indicate that the field F1 cannot be merged with its neighboring fields, E3 or G1. In other words, the field F1 should be de-interlaced by using interpolation. According to the video determining method of the invention, when the decision unit 130 concludes that one field cannot be merged with its preceding or succeeding field in steps 506 and 508, the decision unit 130, in step 512, can directly output a value “3” to indicate that the field cannot be merged with neighboring fields without the detection results obtained by the pattern detector 140 and the second motion detector 150. On the other hand, when the decision unit 130 concludes that one field can be merged with its preceding or succeeding field in steps 506 and 508, the decision unit 130 determines in step 512 the merge direction of the field by the detection result obtained by the pattern detector 140 in step 510 to verify the conclusions obtained in steps 506 and 508. As a result, the detection correctness of the invention is thereby greatly improved.

In practical implementations, in order to facilitate the following stages to perform other video processing functions, such as merging fields or pixel interpolation etc., the decision unit 130 can generate a second indication signal to represent the film mode of the current video sequence according to the detection results of the first and second pattern comparators 142 and 144 of the pattern detector 140. The second indication signal can employ different values or characters to represent the film mode of the video sequence. For example, the second indication signal can use value “0” to represent that the film mode of the video sequence is 2:2 pull-down; use value “1” to represent that the film mode of the video sequence is 3:2 pull-down; and use value “2” to represent that the video sequence is irregular.

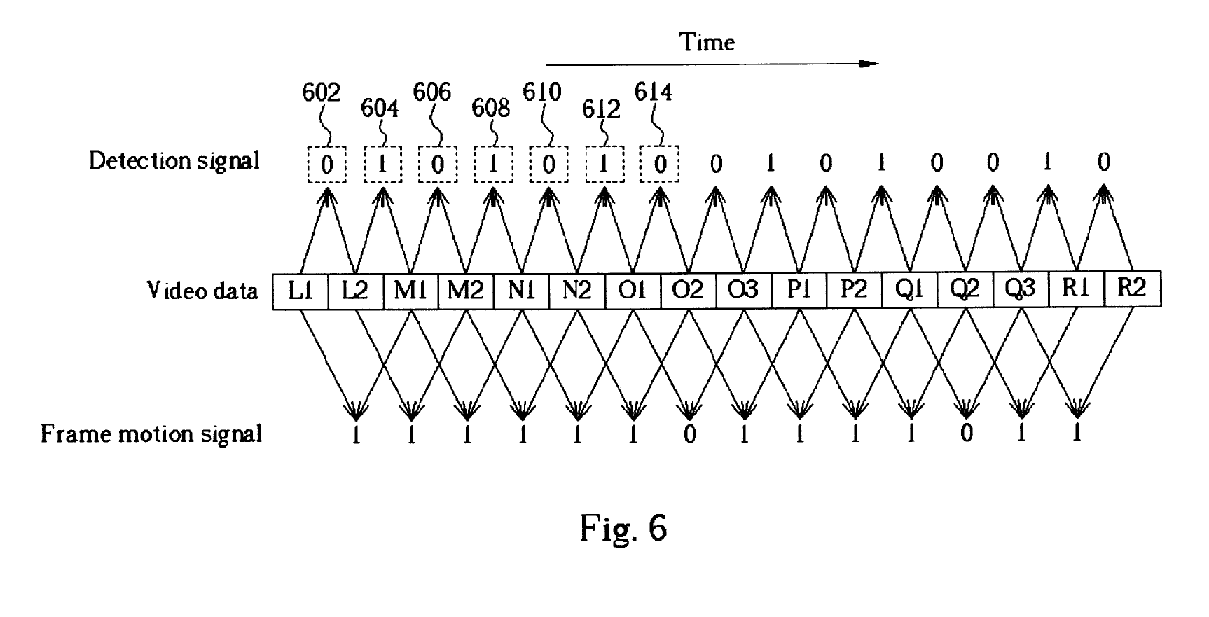

Note that the first and second pattern comparators 142 and 144 of the pattern detector 140 operate independently and both update their detection result depending upon the latest detection signal outputted from the first motion detector 110. In FIG. 6, for example, when the video detector 100 only receives fields L1 and L2, the first motion detector 110 outputs a detection signal 602 corresponding to the field L2. At that moment, both the pattern comparators 142 and 144 cannot determine the film mode for the received fields due to the sequence of detection signals being too short. When the first motion detector 110 outputs a detection signal 604, the second pattern comparator 144 still cannot determine the film mode of the received fields due to the sequence of detection signals being not long enough. The first pattern comparator 142, however, needs only two detection signals to determine the film mode. As shown in FIG. 6, the detection signals 602 and 604 are logic 0 and logic 1, respectively. Since the two detection signals match the “0X” pattern, the first pattern comparator 142 concludes that the current video sequence may be 2:2 pull-down.

The second pattern comparator 144 determines whether the film mode of the video sequence is 3:2 pull-down when receiving five detection signals. For example, the five detection signals 602, 604, 606, 608, and 610 form a “01010” sequence and that matches the “0X0X0” pattern. At that moment, the second pattern comparator 144 concludes that the current video sequence may be 3:2 pull-down accordingly. On the other hand, the last two detection signals 608 and 610 form a “10” sequence and that also matches the “X0” pattern, so that the first pattern comparator 142 concludes that the current video sequence may be 2:2 pull-down. As mentioned above, the detection results of the first pattern comparator 142 and the second pattern comparator 144 are independent of each other. As shown in FIG. 6, when receiving a next field O1, a detection signal 612, logic 1, corresponds to the field O1 is generated. At that moment, the first pattern comparator 142 concludes that the latest film mode may be 2:2 pull-down due to the last two detection signals 610 and 612 form a “O1” sequence. The second pattern comparator 144, however, concludes that the latest film mode is not 3:2 pull-down due to the last five detection signals 604, 606, 608, 610, and 612 form a “10101” sequence which does not match the sequence of 3:2: pull-down.

As illustrated above, the video determining method of the invention can conclude the film mode of the video sequence after receiving only a few fields. In addition, each of the pattern comparators for determining different film modes operates independently. Thus, when the film mode of the video sequence is changed, the invention can conclude that the video sequence is steady if any of the detection results of the pattern comparators is positive. As a result, the number of detection signals required for the pattern detector 140 to determine film mode is greatly reduced. Additionally, while determining the new film mode of the video sequence, the merge direction of each field can be determined simply based on the detection results obtained in steps 506 and 508, or each field can be de-interlaced using a pixel interpolation method.

Those skilled in the art will readily observe that numerous modifications and alterations of the device may be made while retaining the teachings of the invention. Accordingly, the above disclosure should be construed as limited only by the metes and bounds of the appended claims.

1. A method for processing a video signal having successive fields, a first, a second and a third field, the method comprising:
determining whether field motion exists between the first field and the second field and thereupon generating a first detection signal corresponding to the second field; and
determining whether the first field and the second field are capable of being combined according to the first detection signal.

2. The method of claim 1, further comprising:
determining whether field motion exists between the second field and the third field and thereupon generating a second detection signal corresponding to the third field; and
determining whether the second field and the third field are capable of being combined according to the second detection signal.

3. The method of claim 2, wherein if the first and the second detection signals both correspond to a first value, the second field is capable of being combined with the first or the third field.

4. The method of claim 2, further comprising:
comparing the first detection signals with a first pattern of motion sequences and for thereupon generating a first mode signal;
a second pattern comparator for comparing the second detection signals with a second pattern of motion sequences and for thereupon generating a second mode signal; and
determining whether the second field is capable of being combined with the first field according to the first and second mode signals.

5. The method of claim 2, further comprising:
determining whether frame motion exists between the third field and the first field and thereupon generating a frame motion signal; and
determining whether the second field is capable of being combined with the first or the third field according to the frame motion signal.

6. The method of claim 5, further comprising:
comparing a plurality of detection signals with a first pattern and thereupon generating a mode signal; and
verifying whether the second field and the first field are capable of being combined according to the mode signal.

7. The method of claim 1, further comprising:
comparing a plurality of detection signals with a first pattern and thereupon generating a mode signal corresponds to a film mode; and
verifying whether the second field and the first field are capable of being combined according to the mode signal.

8. The method of claim 1, further comprising:
determining whether frame motion exists between fields of the video signal and thereupon generating a frame motion signal; and
verifying whether the second field is capable of being combined with the first field according to the frame motion signal.

9. The method of claim 8, further comprising:
comparing a plurality of detection signals with a first pattern and thereupon generating a mode signal; and
verifying whether the second field and the first field are capable of being combined according to the mode signal.

10. A device for processing a video signal having successive fields, a first, a second and a third field, the device comprising:
a first motion detector for determining whether field motion exists between the first field and the second field and thereupon generating a first detection signal; and
a decision unit coupled to the first motion detector for determining whether the first field is capable of being combined with the second field according to the first detection signal.

11. The device of claim 10, wherein the first motion detector further determines whether field motion exists between the second field and the third field to generate a second detection signal; wherein the decision unit determines whether the second field is capable of being combined with the third field according to the second detection signal.

12. The device of claim 11, further comprising:
a first pattern comparator for comparing the first detection signals with a first pattern of motion sequences and for thereupon generating a first mode signal; and
a second pattern comparator for comparing the second detection signals with a second pattern of motion sequences and for thereupon generating a second mode signal;
wherein the decision unit further determines whether the second field is capable of being combined with the first field according to the first and second mode signals.

13. The device of claim 12, wherein the first and the second patterns are corresponding to 2:2 pull-down mode and 3:2 pull-down mode, respectively.

14. The device of claim 11, further comprising:
a second motion detector for determining whether frame motion exists between fields of the video signal and for thereupon generating a frame motion signal;
wherein the decision unit further determine whether the second field is capable of being combined with the first field according to the frame motion signal.

15. The device of claim 14, further comprising:
a pattern detector coupled to the first motion detector for comparing the first detection signals with a first pattern of motion sequences and for thereupon generating a mode signal;
wherein the decision unit further verifies whether the second field is capable of being combined with the first field according to the mode signal.

16. The device of claim 10, further comprising:
a pattern detector coupled to the first motion detector for comparing the first detection signals with a first pattern of motion sequences and for thereupon generating a mode signal;
wherein the decision unit further verifies whether the second field is capable of being combined with the first field according to the mode signal.

17. The device of claim 10, further comprising:
a second motion detector for determining whether frame motion exists between fields of the video signal and for thereupon generating a frame motion signal;
wherein the decision further verifies whether the second field is capable of being combined with the first field according to the frame motion signal.

18. The device of claim 17, further comprising:
a pattern detector coupled to the first motion detector for comparing the first detection signals with a first pattern of motion sequences and for thereupon generating a mode signal;
wherein the decision unit further verifies whether the second field is capable of being combined with the first field according to the mode signal.
